(19) United States
(12) Patent Application Publication
(10) Pub. No.: US 2013/0190701 A1
(43) Pub. Date: Jul. 25, 2013

(54) MEDICAL TUBE UNCLOGGING SYSTEM AND RELATED METHOD

(71) Applicant: KIRN MEDICAL DESIGN LLC, Lexington, KY (US)

(72) Inventor: David S. Kirn, Lexington, KY (US)

(73) Assignee: KIRN MEDICAL DESIGN LLC, Lexington, KY (US)

(21) Appl. No.: 13/745,903

(22) Filed: Jan. 21, 2013

Related U.S. Application Data
(60) Provisional application No. 61/588,445, filed on Jan. 19, 2012.

(51) Int. Cl. A61J 15/00

(52) U.S. Cl. CPC A61J 15/0026
USPC 604/265; 604/266

(57) ABSTRACT

A medical tube unclogging system includes a power supply, a reservoir of fluid, a tube for insertion into a lumen of a medical tube having a clog therein, a pump powered by the power supply and connected to the tube for generating a flow of fluid from the reservoir of fluid through the tube, a fitting through which the tube passes having a first opening coupled to the medical tube, a second opening for receiving the tube, and a third opening through which fluid pumped through the tube and into the medical tube, and fragments of the clog can be exhausted. The system may also include a sensor for monitoring a pressure of the fluid flowing through the tube and producing a signal indicative of the pressure, and a controller or processor for receiving the signal from the sensor and adjusting the pump.

This application claims the benefit of U.S. Provisional Patent Application No. 61/588,445, filed Jan. 19, 2012, the disclosure of which is incorporated herein by reference.

### FIELD OF THE INVENTION

The present invention relates generally to the unclogging of medical tubes, and more particularly, to a system and related method for unclogging such tubes.

### BACKGROUND OF THE INVENTION

Enteral feeding tubes are commonly utilized in medical practice. These may take the form of nasal-gastric tubes, small bowel tubes, gastrostomy tubes, or other methods. Alternatively, tubes may be used for gastrointestestinal (GI) tract suction or decompression. All tubes used in the GI tract can become clogged. Clogging is usually the result of solidification of an enteral feeding formula, or more commonly a mixture of crushed pills and the enteral feeding formula. Other types of clogs do occur however. If the tube cannot be unclogged, replacement becomes necessary which is costly, uncomfortable for the patient, and exposes the patient to additional risk of complications.

Current methods of tube unclogging include the injection of enzymes or solvents to dissolve the clog and pressure methods to force the clog out of the tube. The enzyme/solvent methods are frequently ineffective due to the particulate nature of crushed medications and the difficulty of dissolving them. Further, clogs can extend for long distances along small bore tubes and the enzyme/solvents only come into contact with the proximal aspect of the obstructing materials. Alternatively, small syringes may be used to generate high pressure within a closed system to unclog a tube. In addition to being minimally effective, the pressure method presents some safety concerns. For example, if the wall of the clogged tube were to rupture from the high pressure proximal to the outlet port at the end, the patient could receive enteral feeding and medications at the wrong level of the GI tract. This could result in reflux or aspiration which can be fatal.

In addition, most tubes are supplied with a guide wire to be used for initial insertion. The wire is withdrawn after the tube is confirmed to be in the proper position. Although one might be tempted to use the guide wire or similar wire to unclog a tube, no wire should be inserted into a tube for safety reasons. Insertion or re-insertion of a wire could lead to penetration through the side of the tube at a point of obstruction or a bend in the tube. Should that circumstance occur, the wire could potentially penetrate the lining of the GI tract in addition to creating an opening proximal to the end of the tube. In summary, although several means of tube unclogging exist, none have been shown to be safe and consistently effective.

Accordingly, a need exists for a system and related method for unclogging medical tubes. The system would preferably not require use of a wire, high pressure in a closed system, or rely solely on enzymes/solvents to unclog the medical tube. Even more, the apparatus would be easy to use and provide features designed to limit patient risk. All of the said features are provided by the following invention. Naturally, any improvements along such lines should contemplate good engineering practices, such as simplicity, ease of implementation, unobtrusiveness, stability, etc.

### SUMMARY OF THE INVENTION

The present invention meets these needs by providing a medical tube unclogging system. In accordance with a first aspect of the invention, the medical tube unclogging system includes a tube for insertion into a lumen of a medical tube having a clog therein, a pump connected to the tube for generating a flow of fluid through the tube, and a fitting through which the tube passes having a first opening coupled to the medical tube, a second opening for receiving the tube, and a third opening through which fluid pumped through the tube and into the medical tube, and fragments of the clog can be exhausted. The tube may include a first portion having an external diameter that is larger than an internal diameter of the medical tube, and a second portion having an external diameter that is smaller than the internal diameter of the medical tube. In addition, the second portion of the tube may be no longer in length than the medical tube, and a reducer for coupling the first and second portions of the tube together may be utilized.

In accordance with other aspects of the invention, the third opening of the fitting is connected to a suction line to assist the exhaustion of the fluid and the fragments, and the flow of fluid generated by the pump is either constant or pulsating.

In yet another aspect of the invention, the medical tube unclogging system includes a sensor for monitoring a pressure of the fluid flowing through the tube and producing a signal indicative of the pressure, and a controller for receiving the signal from the sensor and adjusting the pump to increase, decrease or stop the flow of fluid through the tube generated by the pump. The sensor may be positioned for monitoring a pressure of the fluid adjacent an outlet of the pump, and a bypass valve for releasing fluid from the tube when the sensor determines that the pressure of the fluid flowing through the tube is above a predetermined level may be utilized.

In accordance with another aspect of the invention, a grip through which the tube passes may be utilized for releasably holding the tube during insertion into the lumen of the medical tube having the clog therein. The grip may include a trigger and a cam that contacts the tube for releasably holding the tube during insertion. In addition, the fluid of the flow of fluid may contain an ingestible lubricant to decrease friction between the tube and the medical tube.

In accordance with another aspect of the invention, the medical tube unclogging system includes a power supply, a reservoir of fluid, a tube for insertion into a lumen of a medical tube having a clog therein, a pump powered by the power supply and connected to the tube for generating a flow of fluid from the reservoir of fluid through the tube, a fitting through which the tube passes having a first opening coupled to the medical tube, a second opening for receiving the tube, and a third opening through which fluid pumped through the tube and into the medical tube, and fragments of the clog can be exhausted, a sensor for monitoring a pressure of the fluid flowing through the tube and producing a signal indicative of the pressure, and a controller for receiving the signal from the sensor and adjusting the pump to increase, decrease or stop the flow of fluid through the tube generated by the pump. The tube may include a first portion having an external diameter that is larger than an internal diameter of the medical tube, and a second portion having an external diameter that is smaller than the internal diameter of the medical tube. In addition, the second portion of the tube may be no longer in length than the medical tube, and a reducer for coupling the first and second portions of the tube together may be utilized. In addition, the third opening of the fitting may be connected to a suction line to assist the exhaustion of the fluid and the fragments, and the flow of fluid generated by the pump may be either constant or pulsating.

In another aspect of the invention, a method of unclogging a medical tube having a clog therein includes the steps of coupling a first opening of a fitting to the medical tube having the clog therein, passing a tube into a second opening of the fitting and out of the first opening of the fitting, inserting the tube into a lumen of the medical tube having the clog therein, pumping fluid through the tube, and exhausting the fluid pumped through the tube and into the medical tube having the clog, and fragments of the clog. In addition, the method may include sensing a pressure of the fluid pumped through the tube, producing a signal indicative of the pressure, and adjusting the step of pumping fluid through the tube by increasing, decreasing, or stopping the pumping of fluid.

In accordance with yet another aspect of the invention, a medical tube unclogging system includes a tube for insertion into a lumen of a medical tube having a clog therein, a pump for generating a flow of fluid through the tube, and a connector for connecting the tube and the pump, the connector indicating a size or a length of the tube for use in controlling the flow of fluid through the tube generated by the pump. A fitting through which the tube passes having a first opening coupled to the medical tube, a second opening for receiving the tube, and a third opening through which fluid pumped through the tube and into the medical tube, and fragments of the clog can be exhausted may also be utilized.

The tube may include a first portion having an external diameter that is larger than an internal diameter of the medical tube, and a second portion having an external diameter that is smaller than the internal diameter of the medical tube, the third opening of the fitting may be connected to a suction line to assist the exhaustion of the fluid and the fragments, and the flow of fluid generated by the pump may be either constant or pulsating. In addition, a sensor for monitoring a pressure of the fluid flowing through the tube capable of producing a signal indicative of the pressure may be provided. A controller for receiving the signal from the sensor and adjusting the pump to increase, decrease or stop the flow of fluid through the tube generated by the pump may be used, as well as, a bypass valve for releasing fluid from the tube when the sensor determines that the pressure of the fluid flowing through the tube is above a predetermined level.

Even more, the medical tube unclogging system may include a grip through which the tube passes for releasably holding the tube during insertion into the lumen of the medical tube having the clog therein. The grip may include a trigger and a cam that contacts the tube for releasably holding the tube during insertion. In addition, the fluid used may contain an ingestible lubricant to decrease friction between the tube and the medical tube.

These and other embodiments of the present invention will be set forth in the description which follows, and in part will become apparent to those of ordinary skill in the art by reference to the following description of the invention and referenced drawings or by practice of the invention. The claims, however, indicate the particularities of the invention.

### BRIEF DESCRIPTION OF THE DRAWINGS

The accompanying photographs/drawings incorporated in and forming a part of the specification illustrate several aspects of the present invention and, together with the description, assist in explaining the principles of the invention. In the drawings:

FIG. 1 is a schematic view of the feeding tube unclogging system including a base unit and an unclogging tube;

FIG. 2 is a perspective view of the unclogging tube including a first portion having an external diameter that is larger than an internal diameter of the clogged feeding tube and a second portion having an external diameter that is smaller than the internal diameter of the clogged feeding tube;

FIG. 3 is a partial perspective view of the second portion of the unclogging tube inserted into the clogged feeding tube and showing fluid travelling through the second portion of the unclogging tube, contacting the clog, and fluid and fragments of the clog flowing back through the clogged feeding tube;

FIG. 4 is a side view of a T-shaped fitting through which the unclogging tube passes having a first opening coupled to the clogged feeding tube, a second opening for receiving the unclogging tube, and a third opening through which fluid pumped through the unclogging tube and into the clogged feeding tube, and fragments of the clog are exhausted;

FIG. 5 is a side view of an alternate fitting through which the unclogging tube passes for connection to percutaneous endoscopic gastrostomy (PEG) tubes and the like which utilize one way check valves therein to prevent backflow; and

FIG. 6 is a side view of a grip having a trigger to actuate a cam that contacts the unclogging tube for releasably holding the unclogging tube during insertion into a lumen of the clogged feeding tube.

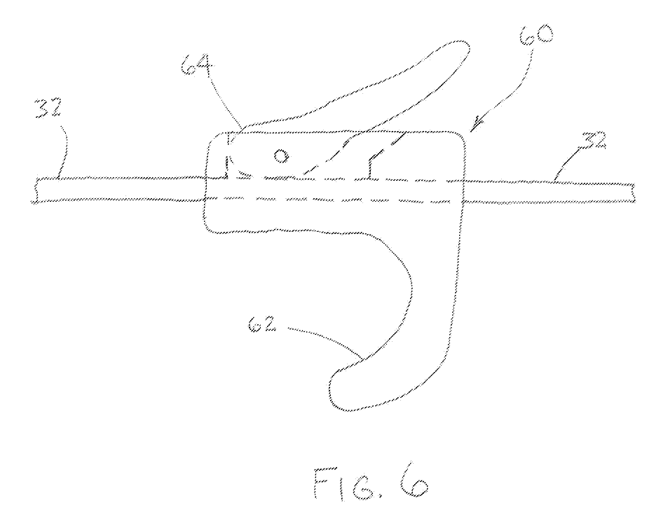

### DETAILED DESCRIPTION OF THE PREFERRED EMBODIMENT

In the following detailed description of the illustrated embodiments, reference is made to the accompanying drawings that form a part hereof, and in which is shown by way of illustration, specific embodiments in which the invention may be practiced. These embodiments are described in sufficient detail to enable those skilled in the art to practice the invention and like numerals represent like details in the various figures. Also, it is to be understood that other embodiments may be utilized and that process, mechanical, electrical, arrangement, software and/or other changes may be made without departing from the scope of the present invention. In accordance with the present invention, methods and apparatus are hereinafter described for monitoring the amount of liquid in at least one container utilizing a non-invasive liquid level sensing system.

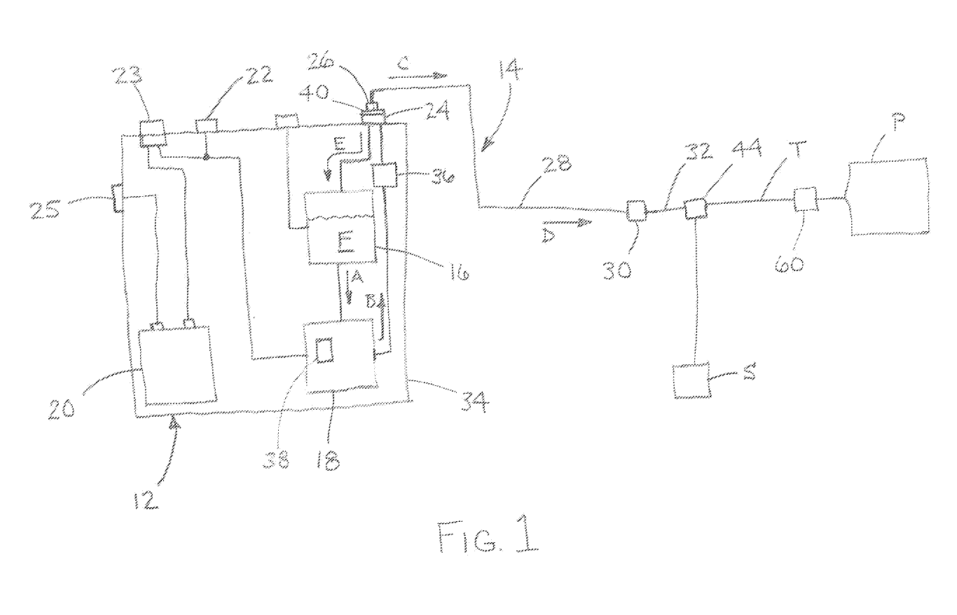

With reference to FIG. 1, a medical tube unclogging system 10 is described having a base unit 12 and a single-use disposable unclogging tube 14. The base unit 12 includes a reservoir 16, a pump 18, a power supply 20, an indicator 22, an off/on switch 23, charging jacks 25, and a connector 24 for connecting with the disposable unclogging tube 14. In this embodiment, the base unit 12 is small and portable to allow for ease of movement (e.g., to be taken to a patient's bedside) and use. The unclogging tube 14 includes a connector 26 to mate with the connector 24 of the base unit 12, a large bore tube 28 to extend between the base unit and the clogged medical tube (T) in the patient (P), a reducer 30 or reducing fitting, and a small bore, preferably minimally elastic, tube 32 which may be passed inside a lumen of the clogged feeding tube (T). For purposes of illustration, the clogged medical tube (T) is hereinafter described as a clogged feeding tube (T). The unclogging tube 14 is further described below. As an extension of the described embodiment, the feeding tube unclogging system 10 could be adapted for use in medical tubes in sterile environments such as urinary catheters or surgical drains by allowing flow of a sterile biocompatible fluid, using a sterile unclogging tube, and sterile base unit components.

The base unit 12 houses the pump 18, power supply 20, and fluid connections within a single case 34. A carrying handle which is not shown could be utilized to assist in moving the base unit 12. The pump 18 creates a pulsatile or a continuous flow of fluid (F) from the reservoir 16 through the unclogging tube 14 as shown by action arrows A through D. A diaphragm pump, a piston pump or any other type of pump mechanism may be used in accordance with the broadest aspects of the invention. Although not required, the embodiment described herein includes a pressure feedback system that is utilized to control an output pressure (Pₒᵤₜ) of the pump 18. A sensor 36 is connected between an outlet side of the pump 18 and the unclogging tube 14 for monitoring the pressure of the fluid (F) flowing through the unclogging tube 14. Action arrow B shows the fluid (F) leaving the output side of the pump 18 and passing through the sensor 36. The sensor 36 produces a signal (Sₒᵤₜ) indicative of the pressure that is communicated to a controller 38.

In the described embodiment, the controller 38 is a microprocessor which receives the signal (Sₒᵤₜ) from the sensor 36. In turn, the controller 38 adjusts the operation of the pump 18 to increase, decrease, or stop the flow of fluid (F) through the unclogging tube 14. In this manner, a pressure operating range or simply a high pressure limit selected to ensure that the flow of fluid (F) is delivered through the unclogging tube 14 at a desired pressure or within selected parameters, is maintained throughout use of the system 10. In accordance with the broad teaching of the invention, any type of controller, processor or the like capable of receiving a signal indicative of pressure and adjusting or controlling the operation of a pump may be used.

In operation, a low pressure situation could result, for example, if the user were to shorten the length of the unclogging tubing 14. The pressure detected by the sensor 36 at the outflow of the pump 18 would read low while an excess pressure would be delivered at the distal end of the unclogging tube 14. In this situation, the sensor 36 would detect the low pressure and signal the controller 38 to adjust pump output accordingly, or shut the system down. In an embodiment where a pump that could generate a pressure high enough to damage the feeding tube or lining of the GI tract were used, then a high pressure limit could be incorporated to avoid those circumstances. In another alternate embodiment, a bypass valve 40 could be incorporated into the system to divert fluid (F) (shown by action arrow E) back to the reservoir 16 in the event of excess pressure.

The pump 18 generates the flow of fluid (F) from the reservoir 16 through the unclogging tube 14 and is electrically operated by a power supply 20. In the described embodiment, the power supply 20 is a rechargeable battery. Charging jacks 25 are provided on the base unit 12 to allow the power supply 20 to be recharged. Alternatively, the power supply 20 can be a disposable battery, an AC-DC power supply or the like, or simply electric line voltage. Even more, the pump 18 could be powered by vacuum lines or compressed gas lines (neither shown in FIG. 1) which are available in most hospitals.

In the described embodiment, the pump 18 is driven by a variable speed motor or solenoid such that the generated flow of fluid (F) from the reservoir 16 and pressure are controlled. The fluid (F) utilized for unclogging medical tubes must be suitable for human ingestion. Water is the preferred unclogging fluid, but other options are possible including acidic compounds such as juice, or mixtures containing enzymatic solvents. In addition, the fluid (F) may contain an ingestible lubricant to decrease friction between the unclogging tube 14 and the medical tube (T). The lubricant can be oil, soap, silicone, or like ingredients having lubricating properties.

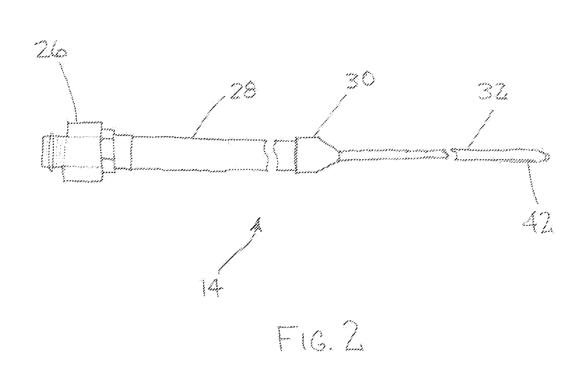

As best shown in FIG. 2, the unclogging tube 14 is a single-use disposable item since it is the only portion of the system which encounters contaminated material. More specifically, the unclogging tube 14 includes a first portion having an external diameter that is larger than an internal diameter of the clogged feeding tube (T) referred to as the large bore tube 28, and a second portion having an external diameter that is smaller than the internal diameter of the clogged feeding tube (T) referred to as the small bore tube 32. The large internal diameter of the large bore tube 28 allows maximal fluid (F) flow and limits pressure drop.

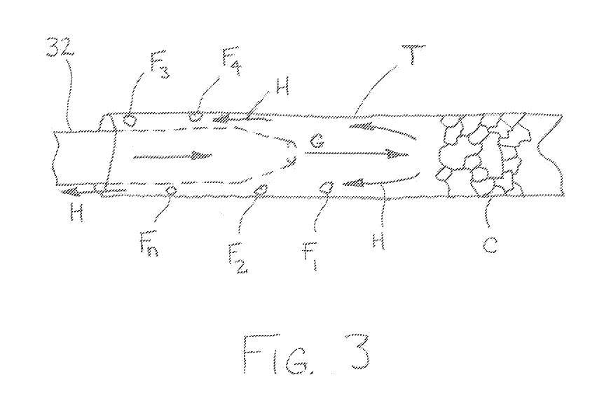

The relationship between the small bore tube 32 and the clogged feeding tube (T) is best shown in FIG. 3. Action arrow G shows the fluid (F) leaving the small bore tube 32 within clogged feeding tube (T) and striking a clog (C). In accordance with the broad teaching of the invention, the fluid (F) erodes the clog (C) breaking fragments (F₁₋ₙ) there from. In the described embodiment, the difference between the diameter of the small bore tube 32 and the clogged feeding tube (T) is sufficient to allow the fragments (F₁₋ₙ) of the clog (C) to pass there between and be exhausted proximally. Until the clog (C) is at least partially cleared, the fluid (F) will return back through the clogged feeding tube (T) carrying the fragments (F₁₋ₙ) therein as shown by action arrow H. Once the clog (C) is at least partially cleared, some of the fluid (F) and fragments (F₁₋ₙ) will flow past the clog into the GI tract while the remainder of the fluid and fragments will continue to return back through the clogged feeding tube (T). Under normal flow circumstances, the drop in fluid pressure between the pump 18 and the distal end 42 of the small bore tube 32 is significant. Thus, high pressure injection injury to the lining of the GI tract is not possible even with direct contact between the distal end 42 of the unclogging tube 14 and the lining of the GI tract. Further, the sensor 36 would add an extra measure of protection against excessive pressure at the distal end 42.

In the described embodiment, the length of the small bore tube 32 is matched to the length of the clogged feeding tube (T) to avoid over insertion. Alternate embodiments could have varying lengths of the small bore tube 32. In addition, the different diameters of the large and small bore tubes 28, 32 prevent over insertion of the small bore tube into the clogged feeding tube (T). In accordance with the broad teaching of the invention, the unclogging tube 14 may be manufactured from multiple parts or integrally molded as a unitary piece. The unclogging tube 14 may also be supplied with a length measure and/or markings printed thereon to allow a user to trim the length of the small bore tube 32 to correspond to the length of the clogged feeding tube (T). A depth stop (not shown) could also be positioned along the length of the small bore tube 32 of the unclogging tube 14 to prevent over insertion as is known in the art.

In the described embodiment, both the large bore tube 28 and the small bore tube 32 of the unclogging tube 14 have minimal elasticity to allow maximal fluid pressure peaks to reach a distal end 42 of the small bore tube. Materials such as polyethylene for the large bore tube 32 and PTFE for the small bore tube 28, for example, are advantageous. As noted above and best shown in FIG. 2, the large and small bore tubes 28, 32 may be joined by a reducer 30 or a reducing fitting. In addition, the distal end 42 of the unclogging tube 14 may be square cut, taper cut, or formed into a nozzle to enhance the pulsatile or continuous flow of fluid (F) emerging there from.

In an alternate embodiment, one or both of connectors 24 and 26 for connecting the unclogging tube 14 to the pump 18 are designed to indicate a size or a length of the unclogging tube for use in controlling the flow of fluid (F) through the unclogging tube 14 generated by the pump. If different sizes or lengths of unclogging tubes are used, a desired pump pressure could be matched to a selected unclogging tube by use of tube-specific flanges located on the connector which trigger a switch located near or adjacent the connector 24. The design of the connector and signaling arrangement would provide optimal fluid flow into the unclogging tube 14, as well as rapid connection/disconnection with the base unit 12.

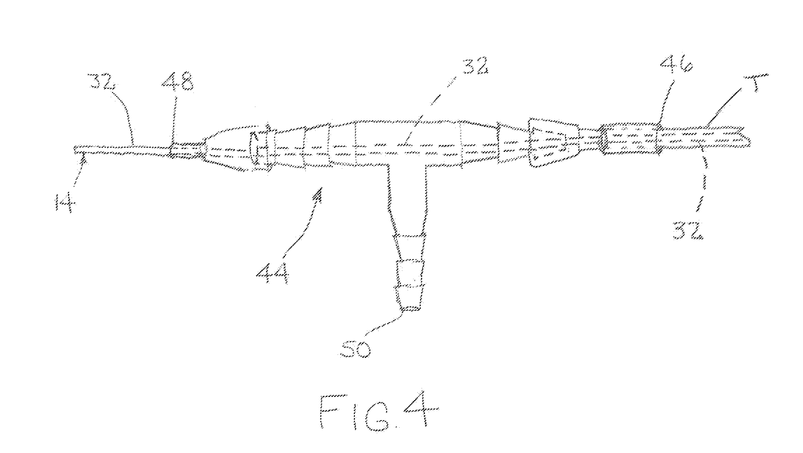

As best shown in FIG. 4, the medical tube unclogging system 10 includes a fitting 44 through which the unclogging tube 14 passes. The fitting 44 includes a first opening 46 coupled to the clogged feeding tube (T), a second opening 48 for receiving the unclogging tube 14, and a third opening 50 through which fluid (F) pumped through the unclogging tube 14 and into the clogged feeding tube, and fragments (F₁₋ₙ) of the clog (C) can be exhausted. In the described embodiment, the fitting 44 is preferably T-shaped and the first and second openings 46, 48 are different diameters. The user can select either of the openings to couple to the clogged feeding tube (T). The minimum internal diameter of the small diameter opening is set so that the unclogging tube 32 can pass through the opening and there is still sufficient area for exhaustion of the fluid (F) and fragments (F₁₋ₙ) returning from the clog (C). The third opening 50 may be left open as shown in FIG. 4 to allow exhaustion of the fluid (F) and fragments (F₁₋ₙ) or connected to a drain tube (not shown) to exhaust the fluid (F) and fragments (F₁₋ₙ) in a controlled fashion. Alternatively, the third opening 50 may be connected to a suction line to assist the exhaustion of the fluid (F) and fragments (F₁₋ₙ).

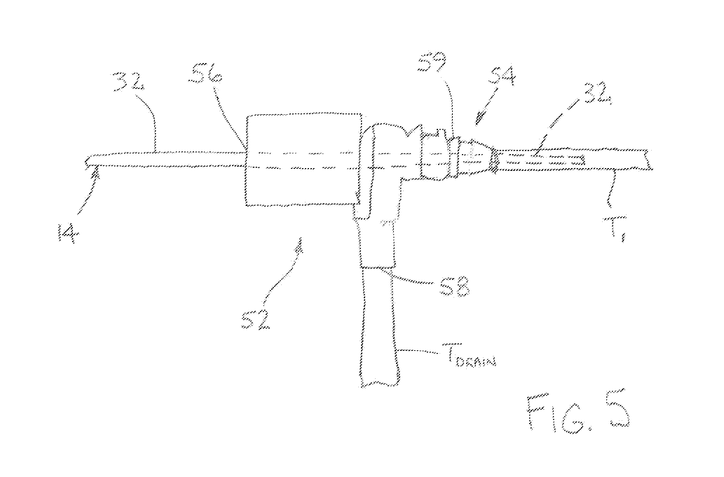

In an alternate embodiment of the invention shown in FIG. 5, the fitting 52 includes a first opening 54 coupled to a clogged tube (T₁), a second opening 56 for receiving the unclogging tube 14, and a third opening 58 through which fluid (F) pumped through the unclogging tube 14 and into the clogged feeding tube, and fragments (F₁₋ₙ) of the clog (C) can be exhausted. In this embodiment, the fitting 52 includes a connector 59 for connecting to percutaneous endoscopic gastrostomy (PEG) tubes and the like which utilize one way check valves therein to prevent backflow. The fitting 52 and connector 59 include a flange (not shown) which extends far enough into the clogged PEG tube (T₁) to maintain the check valve in an open position allowing exhaustion of the fluid (F) and fragments (F₁₋ₙ). The third opening 58 may be left open as shown in FIG. 4 to allow exhaustion of the fluid (F) and fragments (F₁₋ₙ), connected to a drain tube (T_{DRAIN}) to exhaust the fluid (F) and fragments (F₁₋ₙ) in a controlled fashion as shown in FIG. 5, or connected to a suction line to assist the exhaustion of the fluid (F) and fragments (F₁₋ₙ).

As described above, the unclogging tube 14 and/or portions thereof, including the small bore tube 28 and large bore tube 32 may be made of materials such as polyethylene and PTFE. PTFE and similar materials have a natural lubricity. This is advantageous since it assists the insertion of the unclogging tube 14 through the fitting 44 and clogged feeding tube T allowing the tube 14 to pass smoothly. Lubricity, however, can also make insertion difficult for the user due a reduced ability to maintain a good grip on unclogging tube 14 during insertion. This is particularly true if resistance from a clog is encountered.

Accordingly, an alternate embodiment of the invention further includes a grip 60 or gripping tool through which the unclogging tube 14 passes for holding the unclogging tube during insertion into the lumen of the clogged feeding tube (T). The grip 60 is shown in FIG. 1 positioned between the fitting 44 and the patient (P) but placement of the grip can be made anywhere along the unclogging tube 14. As best shown in FIG. 5, the grip 60 includes a trigger 62 and a cam 64 that contacts the unclogging tube 14, or more specifically in this embodiment, the small bore tube 32. Actuation of the trigger 62 rotates the cam 64 to grasp or hold the small bore tube 32 in a releasable manner during insertion of the small bore tube into the lumen of the clogged feeding tube. Alternate grip designs may be used in accordance with the broad teaching of the invention including the more cumbersome screw-type grip, or a piston type grip depressed by a user's thumb or finger.

In a related method of unclogging a medical tube (T) having a clog (C) therein a first opening 46 of a fitting 44 is coupled to the medical tube. An unclogging tube 14 is passed into a second opening 48 of the fitting 44 and out of the first opening 46 and the fitting 44. The unclogging tube 14 and in particular a small bore tube 32 is inserting into a lumen of the clogged feeding tube (T). Fluid (F) is then pumped through the unclogging tube 14 and into the clogged feeding tube (T). The fluid (F) and fragments (F₁₋ₙ) of the clog (C) are then exhausted. The method may further include sensing a pressure of the fluid (F) pumped through the unclogging tube 14 using a sensor 36. A signal indicative of the pressure may be produced, and the pumping of the fluid (F) through the unclogging tube 14 may be adjusted by increasing, decreasing, or stopping the pumping dependent upon the sensed pressure as indicated by the signal.

To use the medical tube unclogging system 10 of the described embodiment, the reservoir 16 is filled with water or other desired fluid (F). A user selects an appropriate length/diameter of a disposable small bore tube 32 of the unclogging tube 14, or trims a longer length tube to correspond with the length of the clogged feeding tube (T). Of note, most feeding tubes have their specifications printed near their proximal end. Unclogging tube 14 and in particular the large bore tube 28 is connected to the base unit 12 using connectors 24, 26. Fitting 44 is coupled to an end of the clogged feeding tube (T) using the appropriate diameter 46 or 48 of the fitting. A drain or vacuum tube (T_{DRAIN}) is attached as desired to a third opening 50 of the fitting 44 for exhausting fluid (F) and fragments (F₁₋ₙ) of the clog (C). The small bore tube 32 is inserted into the second or proximal opening 48 of the fitting 44 and passed into the clogged feeding tube (T). Pump 18 is activated when switch 23 is turned on. Fluid (F) flows from reservoir 16 through pump 18 and out of the distal end of small bore tube 32 of the unclogging tube 14 as shown by action arrows A-D in FIG. 1. The user gradually advances unclogging tube 14 into the clogged feeding tube (T).

The pulsatile or non-pulsatile fluid (F) operates to flush the obstructing material or clog (C) out of the clogged feeding tube (T). Moving the small bore tube 32 of the unclogging tube 14 in an oscillating inserting and withdrawing manner may be helpful. The mechanical force of unclogging tube 14 contacting the clog (C) helps to break up obstructing material in the clogged feeding tube (T) in addition to the fluid flow. The fluid (F) and fragments (F₁₋ₙ) of the clog (C) return proximally between the exterior wall of small bore tube 32 of the unclogging tube 14 and the interior wall of clogged feeding tube (T) as shown by action arrows F₁-Fₙ in FIG. 3. The fluid (F) and fragments (F₁₋ₙ) of the clog (C) are exhausted from the unclogging system 10 through the third opening 50 of fitting 44. This process continues flushing the obstructing material out of the clogged feeding tube (T).

The user is alerted that the clog (C) has cleared when the fluid (F) and fragments (F₁₋ₙ) of the clog (C) are no longer exhausted through the third opening 50 of the fitting 44. Rather, the fluid (F) and fragments (F₁₋ₙ) of the clog (C) take a path of least resistance and are discharged distally into the patient's GI tract. Hence, an ingestible unclogging fluid must be used. The user does not need to insert the small bore tube 32 of the unclogging tube 14 beyond a point at which exhaust fluid (F) ceases to flow. Thus, in the event that the user selected an unclogging tube 14 which was too long, there would be a clear indication to the user that the clogged feeding tube (T) has been unclogged and there is no need to advance further. In this manner, the unclogging tube 14 should never extend beyond the distal end of the clogged feeding tube (T). Advantageously, fluid flow from the unclogging tube 14 also serves to flush and clean the walls of clogged feeding tube (T) proximally and distally to the clog (C) thereby helping to prevent another potential future clog.

The described embodiment of the invention also includes a pressure feedback system that is utilized to control an output pressure (Pₒᵤₜ) of the pump 18. The sensor 36 is connected between an outlet side of the pump 18 and the unclogging tube 14 for monitoring the pressure of the fluid (F) flowing through the unclogging tube 14. When the switch 23 is activated and the pump becomes operational moving fluid (F) from the reservoir and through the sensor 36, the sensor produces a signal (Sₒᵤₜ) indicative of the pressure. That signal (Sₒᵤₜ) is communicated to the controller 38. In turn, the controller 38 adjusts the operation of the pump 18 to increase, decrease, or stop the flow of fluid (F) through the unclogging tube 14. In this manner, a pressure operating range or simply a high pressure limit selected to ensure that the flow of fluid (F) is delivered through the unclogging tube 14 at a desired pressure or within selected parameters, is maintained throughout use of the system 10.

In general, feeding tubes may also be obstructed due to a kink or excessive bend. In these circumstances, two possible results will occur with use of the present unclogging system 10. First, and preferably, passing the unclogging tube 14 through the medical tube may straighten out any kinks therein thereby eliminating the obstruction. The second possibility is that the kink will remain and the user will be unable to pass the unclogging tube 14 distal to the kink. The unclogging tube 14 lacks sufficient rigidity to penetrate through the wall of the feeding tube. So, in this least desired circumstance, the obstruction will remain and the user will have to replace the obstructed medical tube. Even in this suboptimal circumstance, it is important to note that no patient injury would result from use of the unclogging system 10. If the user were to attempt to unclog the clogged feeding tube (T) using a wire or similar rigid material, the wire could penetrate through the wall of the kinked tube and subsequently perforate the wall of the GI tract.

Ultimately, skilled artisans should recognize at least the following advantages. Namely, they should appreciate that the foregoing supports non-invasively measuring liquid levels in one or more containers without the need for specialized containers. The invention also provides the ability to monitor the liquid level in any container irrespective of size, shape or material, and even in multiple containers without the need for multiple probes or human intervention to move an apparatus from one container to another. All of the said features are provided by the following invention. Naturally, any improvements along such lines should contemplate good engineering practices, such as simplicity, ease of implementation, unobtrusiveness, stability, etc.

The foregoing has been described in terms of specific embodiments, but one of ordinary skill in the art will recognize that additional embodiments are possible without departing from its teachings. This detailed description, therefore, and particularly the specific details of the exemplary embodiments disclosed, is given primarily for clarity of understanding, and no unnecessary limitations are to be implied. Modifications will become evident to those skilled in the art upon reading this disclosure and may be made without departing from the spirit or scope of the invention. Relatively apparent modifications, of course, include combining the various features of one or more figures with the features of one or more of the other figures.

1. A medical tube unclogging system comprising:
a tube for insertion into a lumen of a medical tube having a clog therein;
a pump connected to said tube for generating a flow of fluid through said tube; and
a fitting through which said tube passes having a first opening coupled to the medical tube, a second opening for receiving said tube, and a third opening through which fluid pumped through said tube and into the medical tube, and fragments of the clog can be exhausted.

2. The medical tube unclogging system of claim 1, wherein said tube includes a first portion having an external diameter that is larger than an internal diameter of the medical tube, and a second portion having an external diameter that is smaller than the internal diameter of the medical tube.

3. The medical tube unclogging system of claim 2, wherein said second portion of said tube is no longer in length than the medical tube.

4. The medical tube unclogging system of claim 2, further comprising a reducer for coupling said first and second portions of said tube together.

5. The medical tube unclogging system of claim 1, wherein said third opening is connected to a suction line to assist the exhaustion of the fluid and the fragments.

6. The medical tube unclogging system of claim 5, wherein said tube includes a first portion having an external diameter that is larger than an internal diameter of the medical tube, and a second portion having an external diameter that is smaller than the internal diameter of the medical tube.

7. The medical tube unclogging system of claim 1, wherein the flow of fluid generated by said pump is pulsating.

8. The medical tube unclogging system of claim 1, further comprising a sensor for monitoring a pressure of the fluid flowing through said tube and producing a signal indicative of the pressure; and
a controller for receiving the signal from said sensor and adjusting said pump to increase, decrease or stop the flow of fluid through said tube generated by said pump.

9. The medical tube unclogging system of claim 8, wherein the sensor is positioned for monitoring a pressure of the fluid adjacent an outlet of said pump.

10. The medical tube unclogging system of claim 8, further comprising a bypass valve for releasing fluid from said tube when said sensor determines that the pressure of the fluid flowing through said tube is above a predetermined level.

11. The medical tube unclogging system of claim 8, wherein said tube includes a first portion having an external diameter that is larger than an internal diameter of the medical tube, and a second portion having an external diameter that is smaller than the internal diameter of the medical tube.

12. The medical tube unclogging system of claim 11, further comprising a reducer for coupling said first and second portions of said tube together.

13. The medical tube unclogging system of claim 11, wherein said third opening is connected to a suction line to assist the exhaustion of the fluid and the fragments.

14. The medical tube unclogging system of claim 11, wherein the flow of fluid generated by said pump is pulsating.

15. The medical tube unclogging system of claim 1, further comprising a grip through which said tube passes for releasably holding said tube during insertion into the lumen of the medical tube having the clog therein.

16. The medical tube unclogging system of claim 15, wherein said grip includes a trigger and a cam that contacts said tube for releasably holding said tube during insertion into the lumen of the medical tube having the clog therein.

17. The medical tube unclogging system of claim 1, wherein the fluid of said flow of fluid contains an ingestible lubricant to decrease friction between said tube and the medical tube.

18. A medical tube unclogging system comprising:
a power supply;
a reservoir of fluid;
a tube for insertion into a lumen of a medical tube having a clog therein;
a pump powered by said power supply and connected to said tube for generating a flow of fluid from said reservoir of fluid through said tube;
a fitting through which said tube passes having a first opening coupled to the medical tube, a second opening for receiving said tube, and a third opening through which fluid pumped through said tube and into the medical tube, and fragments of the clog can be exhausted;
a sensor for monitoring a pressure of the fluid flowing through said tube and producing a signal indicative of the pressure; and
a controller for receiving the signal from said sensor and adjusting said pump to increase, decrease or stop the flow of fluid through said tube generated by said pump.

19. The medical tube unclogging system of claim 18, wherein said tube includes a first portion having an external diameter that is larger than an internal diameter of the medical tube, and a second portion having an external diameter that is smaller than the internal diameter of the medical tube.

20. The medical tube unclogging system of claim 19, wherein said second portion of said tube is no longer in length than the medical tube.

21. The medical tube unclogging system of claim 19, further comprising a reducer for coupling said first and second portions of said tube together.

22. The medical tube unclogging system of claim 18, wherein said third opening is connected to a suction line to assist the exhaustion of the fluid and the fragments.

23. The medical tube unclogging system of claim 18, wherein the flow of fluid generated by said pump is pulsating.

24. The medical tube unclogging system of claim 18, wherein the sensor is positioned for monitoring a pressure of the fluid adjacent an outlet of said pump.

25. The medical tube unclogging system of claim 18, further comprising a bypass valve for releasing fluid from said tube when said sensor determines that the pressure of the fluid flowing through said tube is above a predetermined level.

26. The medical tube unclogging system of claim 18, further comprising a grip through which said tube passes for releasably holding said tube during insertion into the lumen of the medical tube having the clog therein.

27. The medical tube unclogging system of claim 26, wherein said grip includes a trigger and a cam that contacts said tube for releasably holding said tube during insertion into the lumen of the medical tube having the clog therein.

28. The medical tube unclogging system of claim 18, wherein the fluid of said flow of fluid contains an ingestible lubricant to decrease friction between said tube and the medical tube.

29. A method of unclogging a medical tube having a clog therein comprising the steps of:
coupling a first opening of a fitting to the medical tube having the clog therein;
passing a tube into a second opening of said fitting and out of said first opening of said fitting;
inserting the tube into a lumen of the medical tube having the clog therein;
pumping fluid through said tube; and
exhausting the fluid pumped through said tube and into the medical tube having the clog, and fragments of the clog.

30. The method of unclogging a medical tube having a clog therein of claim 29, further comprising the steps of sensing a pressure of the fluid pumped through said tube;
producing a signal indicative of the pressure; and
adjusting the step of pumping fluid through said tube by increasing, decreasing, or stopping the pumping of fluid.

31. A medical tube unclogging system comprising:
a tube for insertion into a lumen of a medical tube having a clog therein;
a pump for generating a flow of fluid through said tube; and
a connector for connecting said tube and said pump, said connector indicating a size or a length of said tube for use in controlling the flow of fluid through said tube generated by said pump.

32. The medical tube unclogging system of claim 31, further comprising a fitting through which said tube passes having a first opening coupled to the medical tube, a second opening for receiving said tube, and a third opening through which fluid pumped through said tube and into the medical tube, and fragments of the clog can be exhausted.

33. The medical tube unclogging system of claim 32, wherein said tube includes a first portion having an external diameter that is larger than an internal diameter of the medical tube, and a second portion having an external diameter that is smaller than the internal diameter of the medical tube.

34. The medical tube unclogging system of claim 32, wherein said third opening is connected to a suction line to assist the exhaustion of the fluid and the fragments.

35. The medical tube unclogging system of claim 31, further comprising a sensor for monitoring a pressure of the fluid flowing through said tube and producing a signal indicative of the pressure; and
a controller for receiving the signal from said sensor and adjusting said pump to increase, decrease or stop the flow of fluid through said tube generated by said pump.

36. The medical tube unclogging system of claim 35, further comprising a bypass valve for releasing fluid from said tube when said sensor determines that the pressure of the fluid flowing through said tube is above a predetermined level.
